(19) United States
(12) Patent Application Publication
(10) Pub. No.: US 2014/0307914 A1
(43) Pub. Date: Oct. 16, 2014

(54) MEANS FOR TRANSFORMING LUMINAIRES INTO AUDIO EMITTERS

(71) Applicants: Robert Katz, Montreal (CA); Stephen Saint-Vincent, New Braunfels, TX (US)

(72) Inventors: Robert Katz, Montreal (CA); Stephen Saint-Vincent, New Braunfels, TX (US)

(21) Appl. No.: 13/063,076

(22) PCT Filed: Sep. 10, 2009
(86) PCT No.: PCT/US09/05071

§ 371 Date: Jun. 20, 2014

Related U.S. Application Data
(60) Provisional application No. 61/095,876, filed on Sep. 10, 2008.

(51) Int. Cl. H04R 1/02

(52) U.S. Cl. CPC H04R 1/028; H04R 2201/02
USPC 381/390

(57) ABSTRACT

A luminaire used as a soundboard capable of transmitting desired acoustical signals into an environment using an audio transducer, and an acoustical transmission structure as needed, and an audio content delivery system.

### FIELD OF THE INVENTION

The present invention generally relates to audio content distribution systems and, more specifically, to causing luminaires to become audio emitters by interfacing inertial type acoustic actuators and other means to permit desired audio signals to emanate from the luminaire or luminaires and including audio content distribution means.

### BACKGROUND OF THE INVENTION

Bringing audio content to various environments has been the goal of audio equipment builders as well as builders of the environments into which audio signals would be required. By way of example, some of these environments may include office buildings or other private or public use buildings or space.

The use of audio in the form of inertial exciters which may also be described as audio or acoustic transducers has been growing over the years to where their application is more common place in buildings in order to provide various aspects of audio content such as background music, paging, sound masking and other desired audio content.

Conventional audio distribution in commercial building environments utilizes step up transformers on the audio amplifier output stage to typically 70 volts. This higher voltage signal is then carried to a speaker with step down transformer. Although this has simplified wiring of distributed speaker systems, these also have significant limitations in low frequency response, magnetic saturation induced distortion and the inability to customize the speaker output for a given location.

Bringing audio content to these environments in an efficient manner such as to distribute the audio signal in a targeted and dedicated fashion while not encumbering the environments with visually obtrusive audio equipment is a desired improvement over conventional means.

Several common elements typically co-exist within rooms of a building, namely, ceiling, floors, lights, doors, windows, power source, and conduits. Although it is known that certain substrates can act as adequate soundboards for sound transmission, there is needed a simple way both to associate a plurality of sound sources strategically within a room and to power them efficiently.

Causing the audio emitters to become addressable nodes on a computer network would further enhance their utility by using the typically large arrays of audio emitters found throughout any building or space to receive various targeted audio signals and to control their transmission.

It is therefore an object of the present invention to provide a means to cause a luminaire to emit audio content and act as an acoustic source.

It is a second object of the present invention to provide a system to affix an inertial type acoustic transducer to a luminaire.

It is a third object of the present invention to provide a means to augment the acoustic fidelity and transmission of audio content to the luminaire generated by the inertial type audio exciter.

It is a fourth object of this invention to provide a means for the transducer to make contact to transmit audio frequency energy to one or multiple targeted surfaces of the luminaire.

It is a fifth object of this invention cause an array of luminaires to receive similar, or if desired, dissimilar audio content signals at any time.

It is a sixth object of this invention to provide adequate damping of unwanted vibration.

It is a seventh object to use the existing power conduits or wiring to transmit signals to both the luminaire and the audio system, as well as distribute the audio signal.

### SUMMARY OF THE INVENTION

Common to almost all building environments is lighting. This invention is based on disclosing a means to cause a luminaire to act as a soundboard driven by inertial type acoustic drivers. The advantages are numerous and, most significantly, to provide a means to integrate these assemblies so as to save cost of production and installation as well as simplify the visual environment by way of coupling these elements.

The luminaire typically consists of a light source assembly with structural, reflective, optical or decorative elements. These elements are typically constructed of formed material such as sheet steel, glass, composite, aluminum or other material suitable for stated use. These elements sometimes serve a structural role of forming the frame of the luminaire, to which the electronics and light engine assembly are attached or may serve a decorative role.

The present invention takes advantage of the formed reflective elements of the luminaire or other structural or decorative elements of the luminaire,by mechanically or adhesively attaching and acoustically associating an inertial type acoustic transducer. When energized by an appropriate acoustic signal the transducer-associated element will radiate acoustic energy. Means to associate the transducer with the elements of the luminaire are specifically designed to minimize unwanted distorting vibrations and to transmit accurately sound energy to the element of the luminaire intended to operate as the soundboard.

The present invention also takes advantage of the required electrical power distribution structure provided for luminaires as a means of supplying power for the light electronics present in the luminaries as well as the transducers of the audio system. In one embodiment, the emergence of Ethernet over power line technology enables the electrical power distribution cabling to carry lighting control, audio and other control elements using an 802.11.x or like protocol. Using Ethernet distribution means, the audio luminaries may selectively function as single nodes and can be used strategically to disseminate varied audio content signals to audio luminaries forming part of an Ethernet network. As an alternative to sending audio content over power lines the audio content can be delivered over cable forming part of a computer network such as a local area network (LAN) or wirelessly using a radio frequency transmission network.

Other objects, features, and advantages of the present invention will be readily appreciated as the same becomes better understood after reading the subsequent description taken in conjunction with the appendant drawings.

### BRIEF DESCRIPTION OF THE DRAWINGS

In the appended drawings:

FIG. 1A is a top perspective view of a luminaire and audio transducer combination according to a non-restrictive illustrative embodiment of the present invention;

FIG. 1B is an enlarged and detailed perspective view of the audio transducer and transmission structure combination according to a non-restrictive illustrative embodiment of the present invention;

FIG. 2A is an end view of the luminaire, the audio transducer, and the transmission structure according to a non-restrictive illustrative embodiment of the present invention;

FIG. 2B is an exploded view of FIG. 2.

FIG. 3A shows a top perspective view of the transmission structure according to a non-restrictive illustrative embodiment of the present invention;

FIG. 3B shows a bottom perspective view of the transmission structure according to a non-restrictive illustrative embodiment of the present invention;

FIG. 4A is top elevational view of the transmission structure according to a non-restrictive illustrative embodiment of the present invention;

FIG. 4B is bottom elevational view of the transmission structure according to a non-restrictive illustrative embodiment of the present invention;

FIG. 5A is a side elevational view of the transmission structure according to a non-restrictive illustrative embodiment of the present invention;

FIG. 5B is an end elevational view of the transmission structure according to a non-restrictive illustrative embodiment of the present invention;

FIG. 6 is a block diagram showing a distribution system employed with the present invention;

FIG. 7 is a side and exploded view of a second embodiment of the invention showing the audio transducer direct mounted on a luminaire and protruding through a structural surface;

FIG. 8 is a block diagram showing a second distribution system employed with the present invention;

FIG. 9 is a block diagram showing a modification of the second distribution system utilizing multiple modules of luminaire audio units;

FIG. 10 is a block diagram showing another modification of the second distribution system utilizing multiple modules of luminaire audio units and a network adaptor;

FIG. 11 is a block diagram showing another modification of the second distribution system employing multiple modules of luminaire audio units and multiple network adaptors acting as routers to allow for serial connections.

FIG. 12 is a perspective view of the intermediate mounting apparatus of the preferred embodiment of the present invention.

### DETAILED DESCRIPTION OF THE INVENTION

The present invention relates to a means to transmit acoustical energy to elements of a luminaire. Transmission of acoustical energy to the luminaire as provided by the invention causes the luminaire to act as an acoustic soundboard and permit the acoustical vibrations to be audible in the surrounding environment. Depending on their construction and design, various luminaries may have surfaces that would permit them to be used as soundboards when in contact with an audio inertial type transducer. Materials in luminaries such as sheet steel and glass, as well as other construction materials can be made to work well as soundboards.

A luminaire audio system, according to non-restrictive illustrative embodiments of the present invention, will now be described. In a first embodiment, a common fluorescent type luminaire will serve as an example of how a complex luminaire can form part of an audio system, and effectively produce desired sound content.

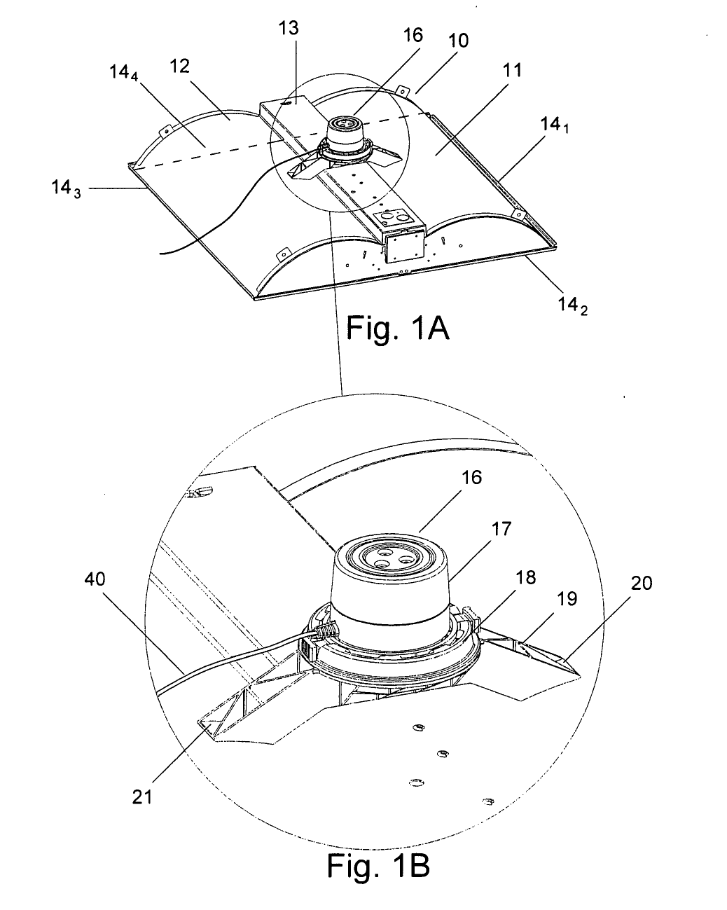

The exemplary luminaire 10 as described in FIG. 1A is a form of fluorescent lighting fabricated in sheet steel with welded joint lines. This particular luminaire comprises two lamps (not shown) encircled by two built in reflector elements 11 and 12 and further comprising a ballast wiring or electronic component housing 13 separating the two reflector elements 11 and 12 it should be noted that a luminaire may include more or fewer reflectors of other surface and that luminaire 10 is only one embodiment of a luminaire that could be employed by the present invention.

The luminaire 10 includes four external edge flanges 14a, 14b 14c and 14d. Placed in a location generally off-set from the central position is an audio transducer 16 more clearly shown in the enlarged detail as shown in FIG. 1B. The off-set aspect prevents dissonant audio output that might otherwise occur in symmetrical applications. The flanges 14a-14d, the lamps, and any other parts within the luminaire 10 are preferably acoustically isolated which can be achieved by spotwelding or inserting a gasket material such as a viscoelastomeric vibratio absorption material e.g. neoprene foam at the interface between such parts.

In FIG. 1B, an audio transducer 16, in this preferred embodiment represented by an inertial type audio actuator 17 is mechanically and acoustically coupled to a transmission structure 19. For the purposes of illustration but not limitations, an intermediate mounting apparatus 18 can be adhesively or mechanically mounted on to the transmission structure 19, and the voice coil actuator 17 may be mechanically coupled to the mounting apparatus 18 using screws, clips, spot welds, springs, tabs, or other mechanical means or may be adhesively secured thereto. The intermediate mounting apparatus 18 comprises a surface 25 and may also include a locking mechanism 182. The locking mechanism of the preferred mounting apparatus 18 may include tabs. The whole can then be affixed to the luminaire 10 at surfaces 11 and 12 by way of contacting surfaces 20 and 21 of the transmission structure 19. A signal and, or power input electrical wire 40 enters the audio transducer 16.

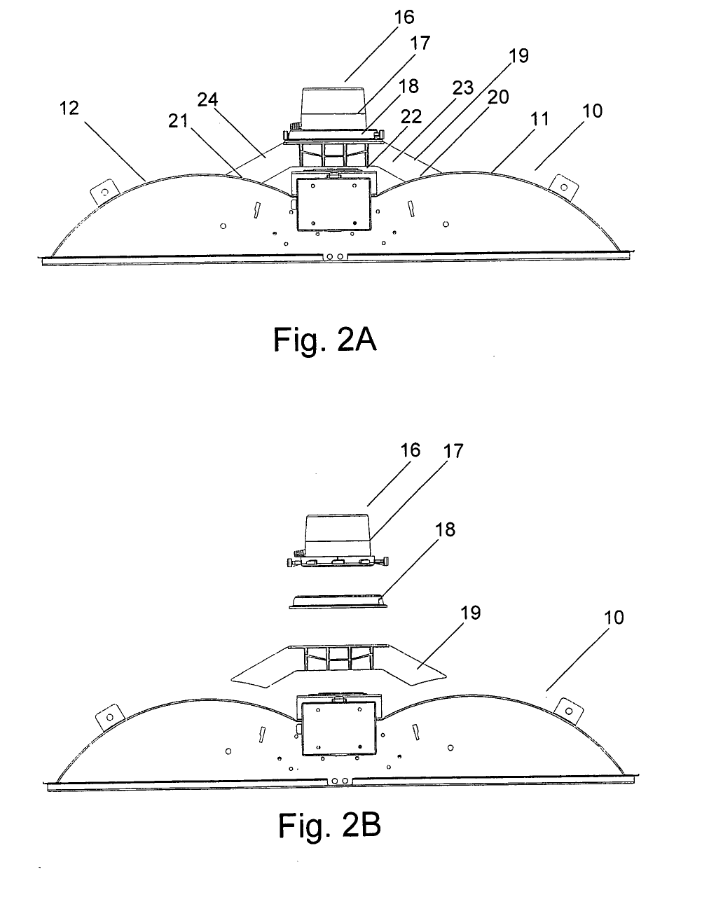

Referring now to FIG. 2, in the preferred embodiment the audio transducer 16 is positioned to transmit acoustical vibrations to the large sheet steel reflector surfaces 11 and 12 of the luminaire 10 in a balanced fashion. The transmission structure 19 comprises materials that are both stiff and light such as but not limited to thin wall die cast aluminum or magnesium. The structure 19 is further characterized by a first leg 23 and a second leg 24 each positioned on a specific surface (11 or 12) of the luminaire. It should be understood that the transmission structure 19 may include additional legs as needed to transmit acoustical vibrations adequately for multi-surfaced luminaires. The legs 23 and 24 transmit acoustical energy from the audio transducer 16 to the large metal surfaces 11 and 12, and contact the luminaire only at the contacting surfaces 20 and 21. It is preferable that all other surfaces of the transmission structure 19 not be in contact with the luminaire save for the contacting surfaces 20 and 21. An air gap 22 provides physical clearance from the housing 13 which is not used as a soundboard in this embodiment.

It should be noted that the transmission structure 19 can be omitted and either a single transducer or multiples can be directly mounted to the luminaire surfaces 11 and, or 12.

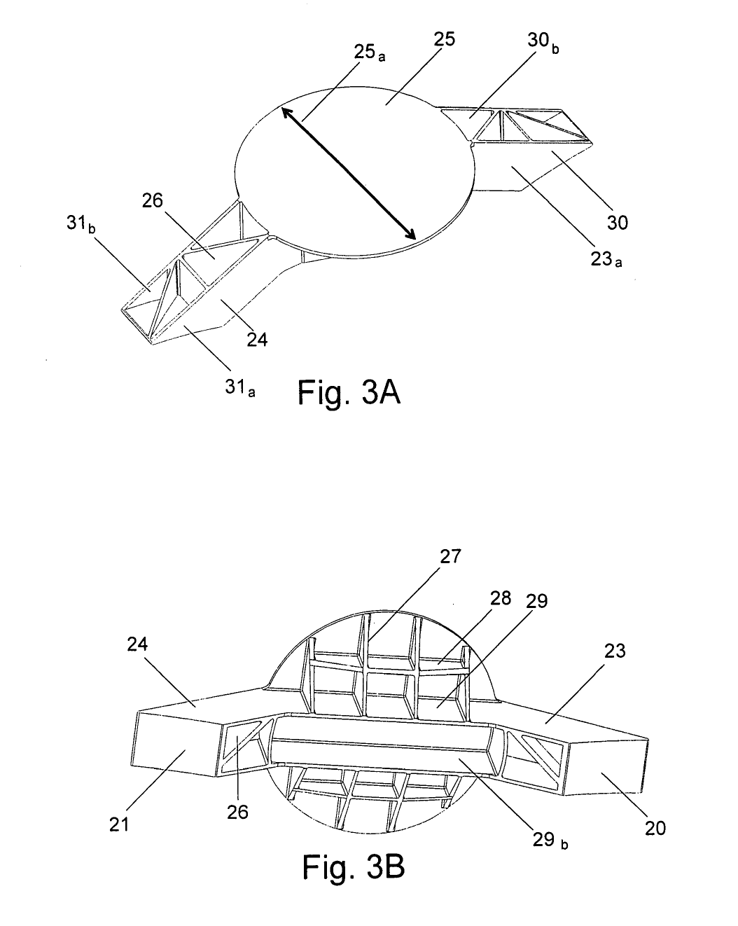

In FIG. 3A, surface 25 illustrates where the audio transducer 16 is placed. Surface 25 is optimally oriented as close to normal as possible to the soundboard surfaces 11 and 12 and has a diameter 25a ideally equal to the contacting area 16a of the audio transducer 16 or the mounting apparatus 18. If numerous surfaces are to be used on the luminaire 10, then the angle of surface 25 can be optimized to transfer energy in proportions best suited to optimize acoustical performance. In this non-restrictive illustrative embodiment, the soundboard surfaces 11 and 12 are symmetrical and therefore are driven at symmetrical angles referencing the centerline.

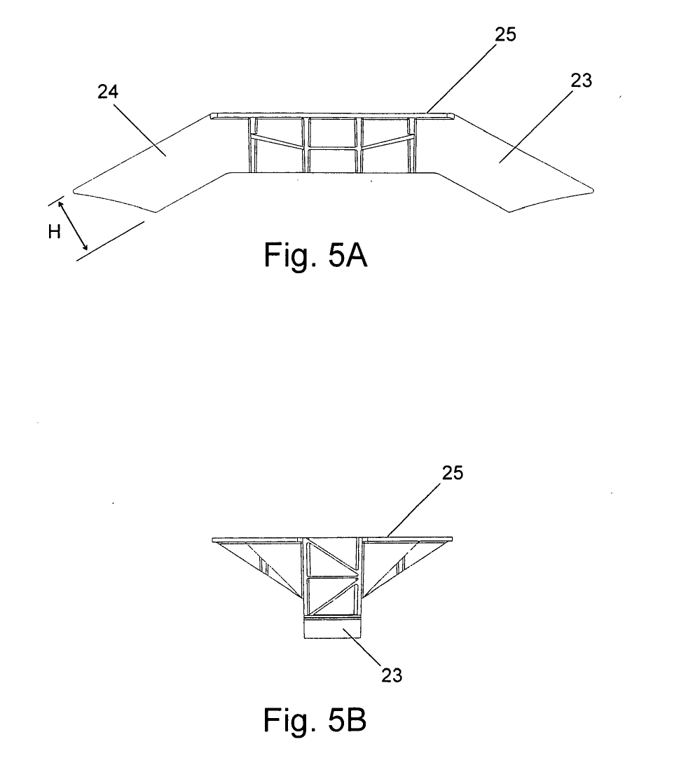

Stiffness and light-weight in the transmission structure 19 is important so as to ensure appropriate acoustic frequency response, and efficiency. FIG. 3A shows leg members 23 and 24 to be more specifically comprised of stiffening walls 30a and 30b as well as 31a and 31b. These stiffening walls have a height H as illustrated in FIG. 5A which further provides stiffness. Referring back to FIG. 3A, in the preferred embodiment stiffening webs 26 can be found throughout leg 23 and leg 24 to further support and stiffen walls 30a and 30b as well as 31a and 31b.

Referring now to FIG. 3B, walls 30a and 30b as well as 31a and 31b of the legs 23 and 24 are joined by walls 29a and 29b. As acoustical energy is transmitted through the transmission structure 19 by way of the surface 25, it is preferable to include additional transverse stiffening ribs 27 and lateral stiffening ribs 28. In doing so, acoustic energy is efficiently passed through the transmission structure 19 to the luminaire 10. This prevents distortion.

The surfaces 20 and 21 of the transmission structure 19 making contact with the luminaire surfaces 11 and 12 are to be affixed to the luminaire 10 ideally over the whole of surface 20 and surface 21. This can easily done with a compatible adhesive or by mechanical means such as but not limited to screws, clips, spring, snaps latches or otherwise and non-mechanical means.

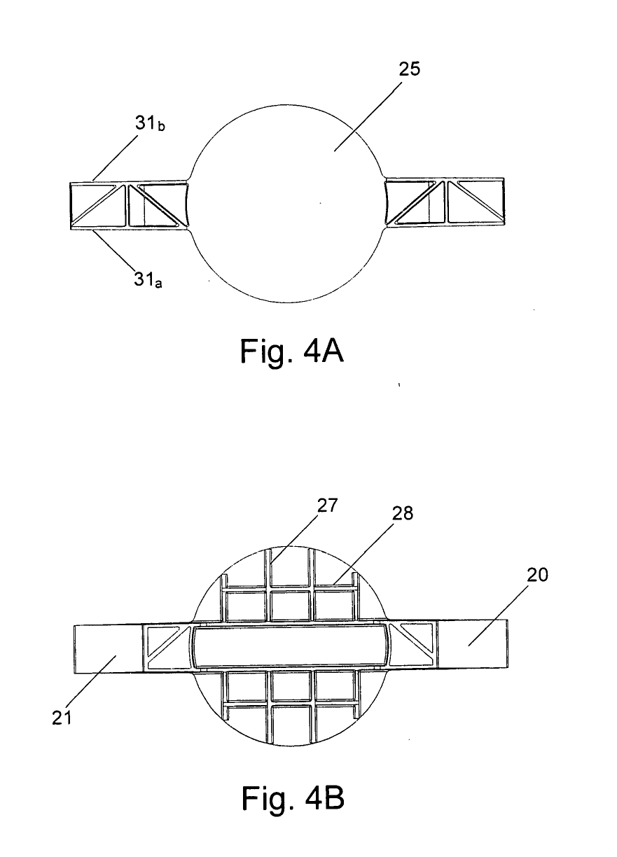

FIGS. 4A, 4B, 5A and 5B show the network of stiffening ribs used throughout the transmission structure 19.

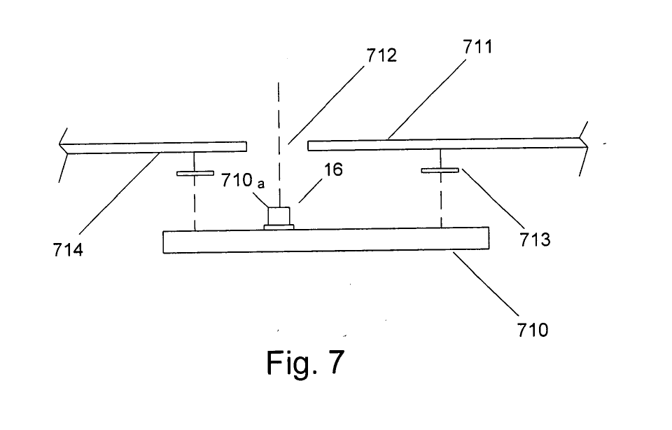

In many luminaries, the inertial type audio transducer 16 may be affixed directly to the luminaire 710, as shown in FIG. 7 without the need of the transmission structure 19, if the geometry of the luminaire structure 710 will permit. This would cause almost all luminaries capable of acting as soundboards to be a candidate for the inventive means described herein. If a luminaire structure 710 is suspended by wires or other means from a ceiling 711, there typically will be no negative repercussions regarding transmission of acoustic vibration into surrounding material. Alternatively, to affix a luminaire 10 directly to a ceiling 711, a relief hole 712 may be required and if so, is made in the ceiling 711 and the audio transducer 16 protrudes from the upper surface 710a of the luminaire 710 through said hole 712. Further, where the luminaire 710 will be affixed or associated with a lower surface 714 of the ceiling 711 or any other structure not intended to function as a sound-board, the luminaire 710 is preferably acoustically isolated from the ceiling 714. Acoustic isolations can be achieved using a gasket material as described hereinabove using means such as a viscoelastomeric vibratio absorption material. An effective means of accomplishing this would be to apply a foam material or other visco-elastomeric material, such as but not limited to an open cell polyurethane foam. So as to isolate the flourescent luminaire 10 of the exemplary embodiment from transmitting acoustical energy to other ceiling elements, edge flanges 14a, 14b, 14c and 14d may be lined with an audio dampening material such as visco-elastic foam, and then assembled into the ceiling structure to produce the same acoustic isolation.

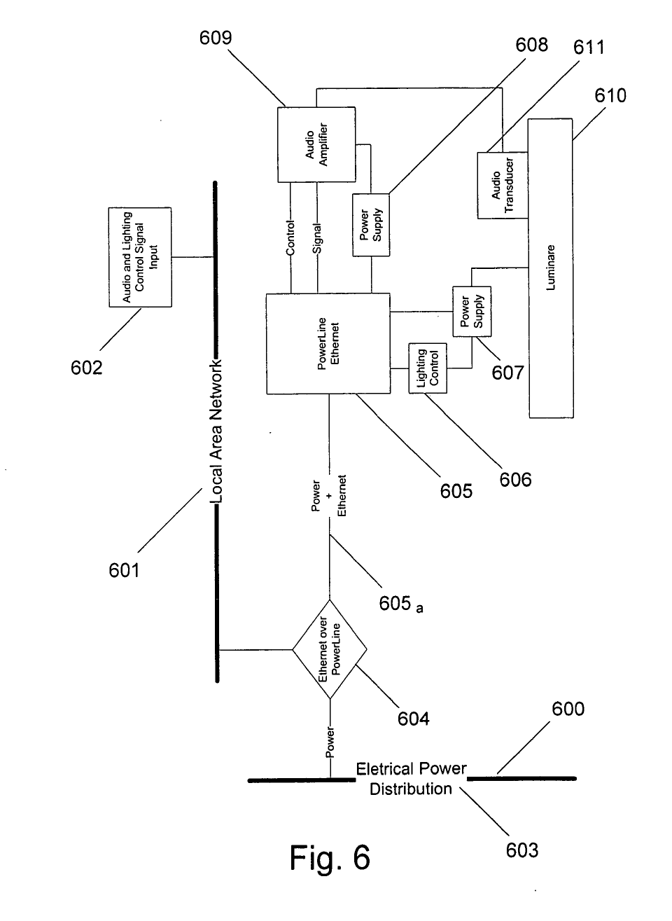

FIG. 6 shows the overall schematic of the preferred embodiment of an integrated light, audio, power and local area network. It should also be noted, that the means now being described can apply for inertial type audio actuators causing materials found within a luminaire to function as the soundboard component of the inertial type audio transducer system. An electrical power distribution network 600 carries electrical power from a distribution bus 603 to the individual luminaire 610 and amplifier 609. A computer, 602 is connected to a local area network 601 and inputs an audio or lighting signal. The signal may contain information such as but not limited to lighting control, audio signal and audio control. An electrical appliance 604 is connected to the electrical power distribution bus 603, which injects the computer signals (which may be Ethernet signals) onto the power line 605a. One commercially available technology is that represented by the HomePlug Powerline Alliance. Electrical power, and Ethernet signal are received at the luminaire node 610 by a bridge 605 which distributes the electrical power to the lighting and audio amplifier power supplies, 607 and 608 respectively. Additionally, a lighting control signal, audio signal and amplifier control signal are conditioned for the appropriate appliance. An audio amplifier 609 then conditions the signal for and supplies the appropriate audio power signal to the audio transducer 611. The lighting control 606 and lighting power supply 607 are then used to power the light of the luminaire 610. The lighting control 606 and the audio amplifier 609 are addressable via the local area network 601, in turn causing the audio transducer devices 16 (in this example, the audio transducer 611) to become addressable nodes on the network 601. It should be noted that the audio amplifier 609 may, alternatively, be integrated into the luminaire 610 as can other elements described and forming part of this system.

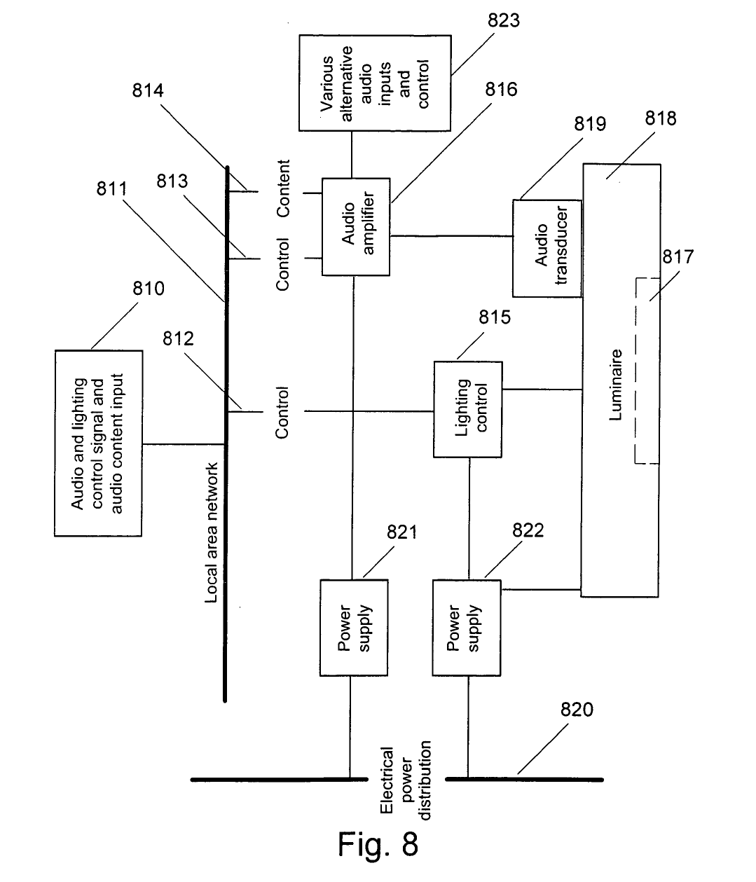

For the purposes of this invention, it should be noted that the audio amplifier 609 may be used in conjunction with an audio transducer that is an inertial type audio actuators. Referring now to FIG. 8, the actuator causes materials found within a luminaire 818 to function as the soundboard component of the inertial type audio transducer system. In this context, the amplifier 816 is configured to have the capability to parametrically equalize the incoming audio content signal 814 or be able to store and utilize a specific audio equalization algorithm to process the audio content signal 814. As the audio transducer 16 (in this example, the audio transducer 819) causes the part or parts of the luminaire 818 to function as a soundboard and by way of this and audio emitter, it is important to tune the audio content signal via equalization to in turn tune that luminaire to work at its maximum potential. Equally the audio amplifier 816 can receive a any combination of audio inputs such as but not limited to analog, digital, and control inputs 823. There are other system architectures that will be obvious to those skilled in the art and some are described below. (see similar text next page).

Referring again to FIG. 8, another such system achieving the same goal could include audio content signal 814, audio control signal 813 and lighting control signal 812 emanating from a main source computer 810. It should be noted that wherever described herein, audio content signal 814, audio control signal 813 may be delivered via a single cable to supply the amplifier 816. The signals travel on a computer network such as but not limited to an Ethernet network described herein as a local area network 811 instead of a power wire or line voltage feed. The signals can then be fed into their respective conditioning elements which would include for example, a lighting control 815 for the lighting control signal 812, an audio amplifier 816 for an audio control signal 813 and the same audio amplifier 816 for an audio content signal 814. Once conditioned, the signals would then be supplied to their appropriate device which is the light source 817 found within the luminaire 818. The audio signals 813 and 814 once conditioned are sent to the audio transducer 819.

Power for the devices and appliances described herein are supplied from an electrical power distribution system 820 which supplies electrical power to a power supply 821 for the audio equipment and then to the audio amplifier 816 and power supply 822 for the lighting control equipment, then to the lighting control device 815. The lighting control 815 and audio amplifier 816 are addressable via the local area network 811, in turn causing the audio transducer devices 16 (in this example, the audio transducer 819) to become addressable nodes on the network.

As the audio transducer 16 (in this example, the audio transducer 819) causes the part or parts of the luminaire 818 to function as a soundboard and by way of this an audio emitter, it is important to tune the audio content signal 814 via equalization so as to, in turn, tune the luminaire 818 to work as a soundboard to its maximum potential. Equally or alternatively, the audio amplifier in any of the distribution systems described herein can receive any combination of alternative audio inputs 823 which can be controlled separately form the computer 810 such as but not limited to analog, digital, SP/DIF.

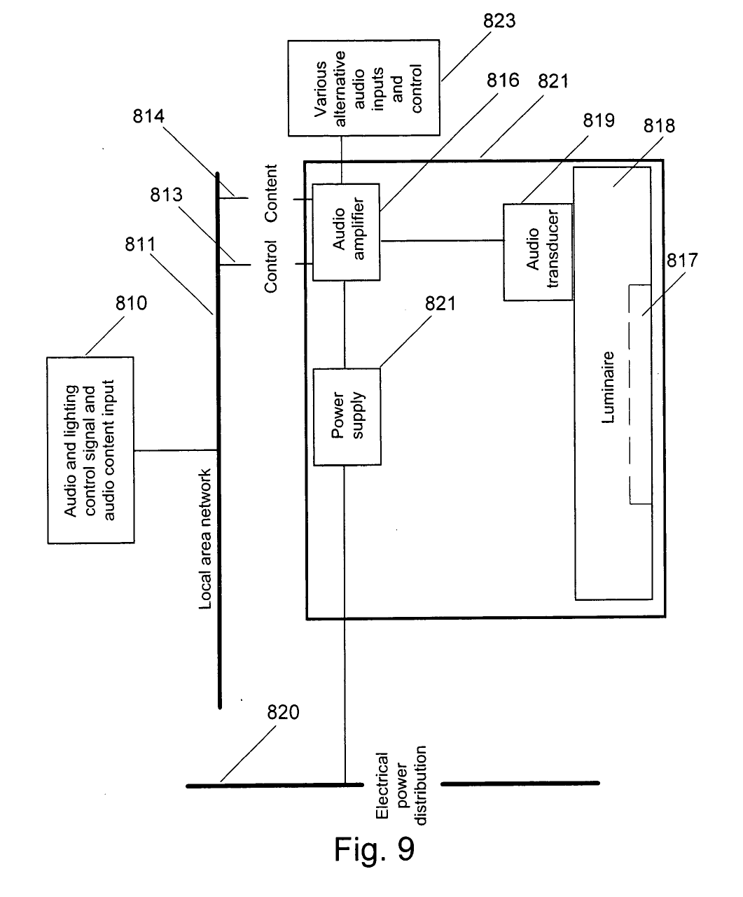

As we have established, each audio transducer 16 (in this example, the audio transducer 819) becomes an addressable nodes on the network, this can be utilized by several useful applications which would further enhance their utility permitting large arrays of audio emitters found throughout any building or space to receive various targeted audio signals and to control their transmission either individually, collectively, in groups or any permutation thereof. Referring to FIG. 9 this aspect of this invention can be simplified by referring to a luminaire audio unit 821. It should be noted that the audio amplifier 816 has been included in this unit 821 but may be found adjacent to the luminaire audio unit 821 if more practicable. The lighting control signal 812 for the luminaire 818 has been omitted in this illustration to permit the focus on the audio control signal 813 and the audio content signal 814.

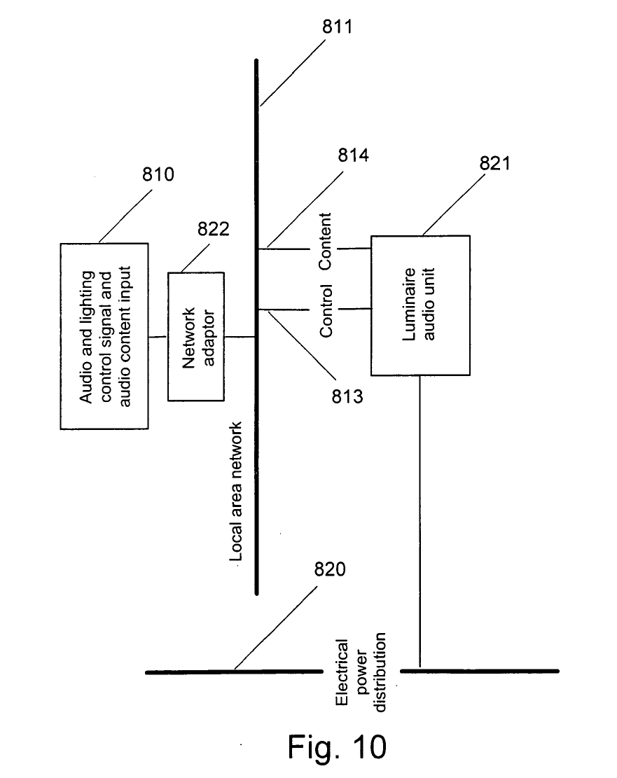

In FIG. 10 the same computer network can be used to supply the array of luminaires which can now be transformed into a luminaire audio system utilizing multiple modules of luminaire audio units 821 found within the array. To assist with the manipulating, conditioning and managing of the transmission and distribution of the audio control signal 813 and the audio content signal 814 from the computer network 811, a network adaptor 822 may be used which is specifically designed for this function. One commercially available technology is that represented by the Cirrus Logic CobraNet audio networking technology.

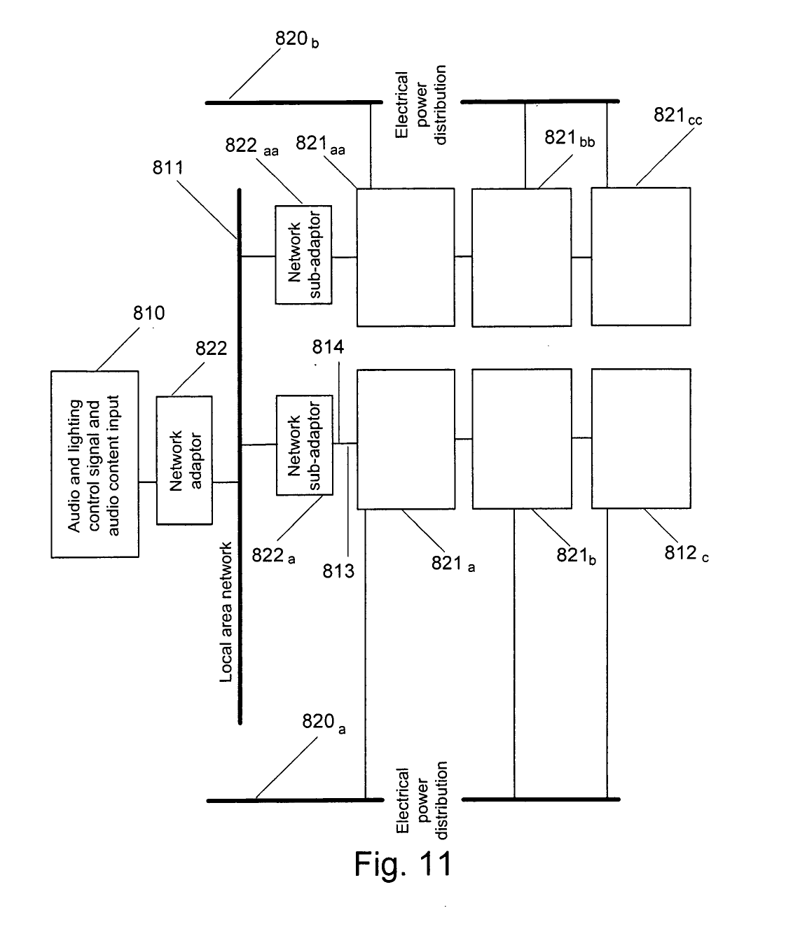

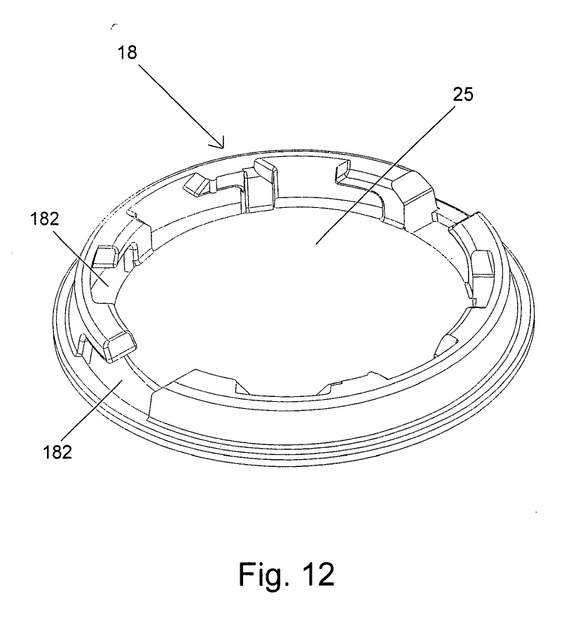

Referring to FIG. 11, this audio signal delivery, control and distribution system may be further enhanced by redistributing the signal from the network adaptor 822 and distributing it to a network sub-adaptor 824, thus permitting longer runs of network cable found in the computer network 811 where audio quality or content signal 814 may otherwise deteriorate. The network sub-adaptor 824 utilizes algorithms to correct the audio content signal 814 as required for distribution and may have additional ports emanating from the network sub-adaptors whereby luminaire audio unit 821 may be assembled in serial chains as shown by luminaire audio units 821a, 821b and 821c, as well as serially connected luminaire audio units 821aa, 821bb, 821cc. This serial connectivity is a functional byproduct of such a computer network distribution means. Different serially connected luminaire audio units 821 may be supplied power from additional electrical power lines 820a. Multiple luminaire audio units 821 can form each serial chain as shown and is not limited to the number of luminaire audio units 821 shown.

It should be noted that someone skilled in the art may add radio frequency, optical, or other audio control and content transmission means to replace the transmission of audio content 814 signals and audio control signals 813 via power and Ethernet cables 605a or wired computer networks such as but not limited to the local area computer network 811.

Various luminaries and associated luminaire structures may serve well for the purposes described herein. Generally, a luminaire which typically is comprised of an assemblage of parts, should ideally have all parts cohesively assembled to prevent vibration on the mating surfaces of the assembled parts when acoustics energy in applied via the inertial type acoustics transducer. By way of example, welded parts or adhesively affixed parts typically serve well for the purposes intended. Failing this, acoustics energy absorbing visco elastomeric material such as that described hereinabove should be placed between the mating surfaces of the assembled parts to attenuate and eliminate any undesirable acoustic vibration.

The present invention has been described in an illustrative manner. It is to be understood that the terminology which has been used is intended to be in the nature of words of description rather than of limitation. Many modifications and variations of the present invention are possible in light of the above teachings. For example, luminaires with multiple surfaces intended to be used as soundboards may require a transmission structure with several legs and contacting surfaces in order to manage sound distortion. The web structures within the transmission structure will be adjusted accordingly to produce accurate stiffness relative to the material of the transmission structure and the necessary contact surfaces with the luminaire. The audio transducer can include, without limitation, inertial type voice coil actuators. Therefore, within the scope of the appended claims, the present invention may be practiced otherwise than as specifically described.

1. A luminaire audio system comprising a luminaire having a surface, an audio transducer, and means to acoustically associate said luminaire and said audio transducer to induce said luminaire to become an audio emitter.

2. The luminaire audio system of claim 1 wherein said means to acoustically associate comprises a transmission structure.

3. The luminaire audio system of claim 2 wherein said transmission structure comprises at least one contacting surface mechanically associated with said luminaire.

4. The luminaire audio system of claim 2 wherein said transmission structure comprises at least one contacting surface adhesively associated with said luminaire.

5. The luminaire audio system of claim 2 wherein said means to acoustically associate further comprises an intermediate mounting apparatus.

6. The luminaire audio system of claim 5 wherein said audio transducer is mechanically associated with said intermediate mounting apparatus.

7. The luminaire audio system of claim 1 wherein said audio transducer comprises an inertial type acoustic actuator.

8. The luminaire audio system of claim 5 wherein said intermediate mounting apparatus comprises a disc and a locking mechanism.

9. The luminaire audio system of claim 1 wherein said means to acoustically associate comprises a first leg having a first contacting surface and a second leg having a second contacting surface, said first contacting surface and said second contacting surface each acoustically associated with said luminaire.

10. The luminaire audio system of claim 9 wherein said means to associate contacts said luminaire at no other point.

11. The luminaire audio system of claim 9 wherein said luminaire comprises a plurality of additional components and means for generally acoustically isolating each of said plurality of components from at least one other of said plurality of additional components.

12. The luminaire audio system of claim 1 further comprising an electrical power distribution network, a local area network having a computer, a lighting control, an audio control, and an audio signal routed to an amplifier associated with at least one audio transducer, said audio amplifier addressable by said local area network causing said at least one audio transducer to be addressable by said local area network.

13. A luminaire audio system comprising a luminaire, a structural surface, an audio transducer, and means to mechanically associate said luminaire and said structural surface.

14. The luminaire audio system of claim 13 wherein said audio transducer at least partially protrudes from said luminaire and said structural surface comprises an opening through which said audio transducer is at least partially inserted.

15. The luminaire audio system of claim 14 wherein means to mechanically associate said luminaire and said structural surface comprises viscoelastomeric material providing substantially acoustic isolation.

16. A luminaire audio system comprising a luminaire, an audio transducer, and a means to acoustically associate said luminaire and said audio transducer to induce said luminaire to become an audio emitter said means to acoustically associate comprising a transmission structure and an intermediate mounting apparatus.

17. The luminaire audio system of claim 16 wherein said transmission structure comprises at least one leg having at least one contact surface and said intermediate mounting apparatus comprises a disk wherein said contact surface contacts said luminaire and said disk contacts said audio transducer allowing said luminaire to function as a soundboard.

18. The luminaire audio system of claim 17 wherein said at least one contact surface substantially fully contacts said luminaire.

19. The luminaire audio system of claim 16 wherein said luminaire comprises at least one flange and a viscoelastomeric material provides substantially acoustic isolation between said luminaire and said at least one flange for damping audio distortions.

20. The luminaire audio system of claim 16 further comprising an electrical power distribution network having a computer, an audio amplifier, a local area network having at least one cable on which signals and power are transported to said audio amplifier said amplifier having means to adjust frequency equalization of the audio signal for tuning said luminaire wherein said audio amplifier comprises an addressable node on said network.

21. The luminaire audio system of claim 16 further comprising an electrical power distribution network having a computer, an Ethernet over power system for transporting signals over a power line, and an audio amplifier for conditioning said signal and providing said signal to said audio transducer wherein said audio transducer comprises an addressable node on a local area network.

22. The luminaire audio system of claim 20 wherein said electrical power distribution network further comprises at least one network adaptor and distributes said audio signal via a plurality of ports to a plurality of said audio transducers connected in series.

23. The luminaire audio system of claim 16 wherein said audio transducer comprises the capability to receive signals over a local area network.

24. The luminaire audio system of claim 16 wherein said audio transducer comprises the capability to receive signals over a wireless local area network.
